(19) United States
(12) Patent Application Publication
(10) Pub. No.: US 2024/0088720 A1
(43) Pub. Date: Mar. 14, 2024

(54) SYSTEMS FOR PROVIDING ELECTROMAGNETIC RADIATION INPUT TO FREE ELECTRON LASERS IN FLIGHT, AND ASSOCIATED METHODS

(71) Applicant: Electric Sky Holdings, Inc., Mercer Island, WA (US)

(72) Inventor: Jeffrey Greason, Midland, TX (US)

(21) Appl. No.: 18/349,835

(22) Filed: Jul. 10, 2023

Related U.S. Application Data
(60) Provisional application No. 63/359,988, filed on Jul. 11, 2022.

(51) Int. Cl. H02J 50/20; H01S 3/09; H02J 50/30

(52) U.S. Cl. CPC H02J 50/20; H01S 3/0903; H02J 50/30; H02J 2310/44

(57) ABSTRACT

Systems for transmitting power to and from flight vehicles, and associated devices and methods are described herein. A representative flight power-transmission system includes a surface-based transmitter on or adjacent to the surface of the Earth, a flight platform remote from the surface-based transmitter, and a free electron laser (FEL) carried by the flight platform. The transmitter is configured to transmit electromagnetic radiation to the FEL, and the FEL is configured to receive at least a portion of the electromagnetic radiation from the FEL and generate a laser beam based at least in part on the received electromagnetic radiation. The flight platform can be an aerostat positioned at high altitude within the stratosphere. The FEL can direct the laser beam for one or more end uses, such as (i) supplying power to a downrange electric aircraft, (ii) supplying power to a surface-based receiver, (iii) providing directed-energy for destroying or disabling a target, and/or (iv) providing directed-energy for clearing orbital debris.

### CROSS-REFERENCE TO RELATED APPLICATION

This application claims the benefit of U.S. Provisional Patent Application No. 63/359,988, filed Jul. 11, 2022, and titled “SYSTEMS FOR PROVIDING ELECTROMAGNETIC RADIATION INPUT TO FREE ELECTRON LASERS, AND ASSOCIATED METHODS,” which is incorporated herein by reference in its entirety.

### TECHNICAL FIELD

The present technology is generally directed to systems, devices, and methods for providing electromagnetic radiation input to free electron lasers and, more particularly, for example, to transmitting radio frequency radiation input from a ground-based transmitter to a free electron laser while in flight.

### BACKGROUND

Free electron lasers (FELs) have been used for decades in ground installations. FELs generate radiation via an active gain medium comprised of a beam of electrons, rather than via stimulated emission from atomic or molecular excitations as in many conventional gas and solid-state lasers. More specifically, FELs directly convert the kinetic energy of the electron beam into light. For example, the electron beam can be passed through a linear accelerator (linac) with an electromagnetic wave (e.g., a radio wave) to output a laser beam.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology.

FIG. 1 is a schematic diagram of a power transmission system in accordance with embodiments of the present technology.

FIG. 2 is a schematic diagram of a free electron laser of FIG. 1 in accordance with embodiments of the present technology.

FIG. 3 is a schematic diagram of the free electron laser of FIG. 2 coupled to an energy recovery linear accelerator in accordance with embodiments of the present technology.

FIG. 4 is a schematic diagram of the power transmission system of FIG. 1 in accordance with additional embodiments of the present technology.

FIG. 5 is a schematic diagram of a system for heating lift gas within an aerostat in accordance with embodiments of the present technology.

### DETAILED DESCRIPTION

Aspects of the present technology are directed generally toward methods of using airborne and/or in-space free electron lasers (FELs) to transfer power over long distances, and associated devices and systems. In some embodiments, a method of transferring power using a flight FEL comprises flying a flight platform carrying the FEL at an altitude relative to a ground-based (e.g., surface-based) transmitter. The flight platform can be an aerostat, an aircraft, a satellite, and/or another vehicle, and the altitude can be within the atmosphere (e.g., within the stratosphere) or in space. The method can further comprise transferring electromagnetic radiation from the ground-based transmitter to the FEL. The electromagnetic radiation can comprise radio frequency (RF) radiation. The method can further comprise receiving at least a portion of the electromagnetic radiation at the FEL and generating, via the FEL, a laser beam based at least in part on the electromagnetic radiation. The FEL can direct the laser beam downrange from the flight platform to remote vehicles (e.g., aircraft, unmanned flight vehicles (UAVs), satellites, other FEL carrying flight platforms) which can utilize the laser beam to generate power. In other embodiments, the FEL can direct the laser beam toward a ground-based receiver for power generation at the ground-based receiver, toward orbital debris to remove/clear the orbital debris, toward a target (e.g., missile, aircraft) as a directed-energy weapon to disable, damage, and/or destroy the target, and/or toward other systems for other purposes.

Lasers have been used infrequently for transferring power to high altitude. For example, many frequencies of laser light are blocked or severely dissipated by the troposphere—the atmospheric layer closest to ground. The troposphere contains a large fraction of the total atmosphere's water vapor. Lasers can also be impeded by adverse weather such as rain and snow, as well as by airborne particles generated from forest fires and other combustion. Much of this impeding weather and airborne particles occurs in the troposphere. In some aspects of the present technology, the ground-based transmitter transfers the electromagnetic radiation at frequencies that easily transit the troposphere, such as RF, to power the FEL operating on the flight platform. In some embodiments, the flight platform carrying the FEL can be positioned near the top of or above the troposphere, where laser light is far less impeded by the atmosphere.

The FEL has two inputs: (1) a radio wave or other electromagnetic radiation and (2) an electron beam. The output of the FEL is a tunable laser beam. FELs are uniquely able to emit long wave infrared (LWIR) laser light, which brings at least two advantages. First, LWIR propagates freely in the stratosphere (e.g., above ˜5.5 kilometers (18,000 ft) at some latitudes), limited by the curvature of the Earth. In some aspects of the present technology, the flight platform carrying the FEL can be positioned within the stratosphere at, for example, 30 kilometers (100,000 feet) altitude such that it can direct the laser beam toward (e.g., share energy with) other flight vehicles up to 400 kilometers (249 miles) away with all portions of the resultant laser energy beam remaining above an altitude of 18 kilometers (60,000 feet)—the typical upper limit of a national air space. Second, LWIR is blocked by the troposphere (the atmospheric layer below the stratosphere) such that sharing power among stratospheric aircraft would not inadvertently impact people, structures, etc., on the ground with the laser beam 105.

In some embodiments, the frequency of the laser beam output of the FEL can be changed and/or designed to one that undergoes little or no absorption in the troposphere, such that a greater portion of the laser beam's total power reaches the ground (which may, in some cases, include passing through a national airspace). Accordingly, the FEL platform can transmit laser energy to receivers on the ground.

FELs have demonstrated power levels up to one gigawatt. Their power flow is limited largely by the input flows (often a radio wave and an electron beam). Efficiency enhancements make them suitable for operation aboard flight vehicles. In some embodiments, the FEL is powered by radio waves transmitted from the ground-based transmitter. In some embodiments, the ground-based transmitter can transmit the radio waves as a non-Gaussian Whisper Beam transmission that self-focuses the radio waves over long distances. Such a non-Gaussian Whisper Beam transmission can be funneled directly into the FEL as radio wave input, and the remainder of the non-Gaussian Whisper Beam transmission can be rectified into electricity onboard the flight platform carrying the FEL to generate the electron beam input to the FEL. The autofocusing behavior of a Whisper Beam transmission can enable various aspects and/or features of flight FELs, as described in detail below.

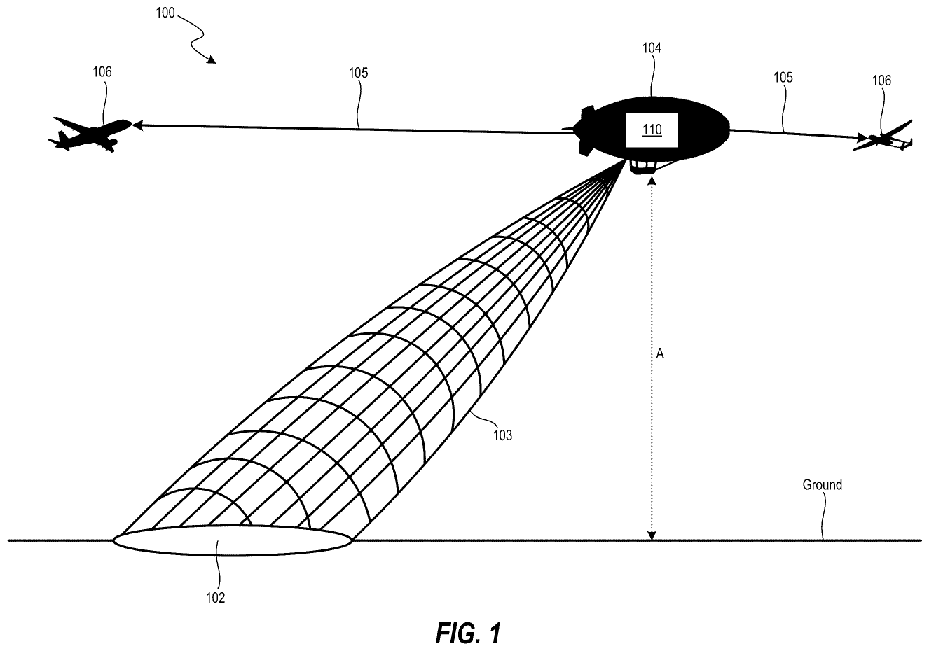

Certain details are set forth in the following description and in FIGS. 1-5 to provide a thorough understanding of various embodiments of the present technology. In other instances, well-known structures, materials, operations, and/or systems often associated with free electron lasers (FELs), radio transmitters, ground transmitters, aircraft, unmanned flight vehicles (e.g., unmanned aerial systems (UAVs)), unmanned flight systems (e.g., unmanned aerial systems (UASs)), unmanned flight systems linear accelerators, energy recovery linear accelerators, and the like, are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth. The terminology used below is to be interpreted in its broadest reasonable manner, even though it is being used in conjunction with a detailed description of certain examples of embodiments of the technology.

The accompanying Figures depict embodiments of the present technology and are not intended to limit its scope unless expressly indicated. The sizes of various depicted elements are not necessarily drawn to scale, and these various elements may be enlarged to improve legibility. Component details may be abstracted in the Figures to exclude details such as position of components and certain precise connections between such components when such details are unnecessary for a complete understanding of how to make and use the present technology. Many of the details, dimensions, angles and other features shown in the Figures are merely illustrative of particular embodiments of the disclosure. Accordingly, other embodiments can have other details, dimensions, angles and features without departing from the present technology. In addition, those of ordinary skill in the art will appreciate that further embodiments of the present technology can be practiced without several of the details described below.

To the extent any materials incorporated herein by reference conflict with the present disclosure, the present disclosure controls.

FIG. 1 is a schematic diagram of a power transmission system 100 (“system 100”) in accordance with embodiments of the present technology. The system 100 includes a ground-based power transmitter 102 (“transmitter 102”), a flight power-relay platform 104 (“platform 104”), and one or more flight vehicles 106 positioned downrange of the platform 104. The transmitter 102 is positioned to transmit electromagnetic radiation 103 (e.g., electromagnetic energy, radiofrequency (RF) waves) to the platform 104. The platform 104 carries a free electron laser (FEL) 110 that utilizes the electromagnetic radiation 103 to generate a laser beam 105, and the FEL can direct the laser beam 105 downrange to one or more of the flight vehicles 106. The flight vehicles 106 can convert the laser beam 105 to power for operating onboard systems, such as propulsion systems. Accordingly, the system 100 can be referred to as an flight power transmission system, an flight power relay system, a flight FEL system, a FEL power relay system, and/or like.

The platform 104 can be an aircraft, unmanned flight vehicle (UAV), aerostat, winged vehicle, missile, space launch vehicle, satellite, spacecraft, and/or other flying vehicle configured to fly in the atmosphere or in space above the ground (e.g., the surface of the Earth) at an altitude A. The platform 104 can be configured to loiter or primarily operate at the altitude A. The altitude A can be relatively high, such as, for example, between 18-50 kilometers (60,000-164,000 feet) or higher in the stratosphere, or in the mesosphere (the third highest layer of the atmosphere, between approximately 50-85 kilometers (31-53 miles), or in the thermosphere (the fourth highest layer of the atmosphere, between approximately 85-690 kilometers (53-429 miles), or higher. Operating at high altitude can provide several advantages. For example, the laser beam 105 comprising laser light—in particular long-wave infrared (LWIR) light—can be relatively unimpeded in the stratosphere and above such that Earth's curvature becomes the primary limitation on range. Accordingly, the higher the altitude A at which the platform 104 operates, the longer the reach of the laser beam 105 around the Earth's curvature to supply laser power to the flight vehicles 106 positioned remote from the platform 104. Furthermore, in some aspects of the present technology it may be desirable for the laser beam 105 to stay entirely above a threshold altitude while traversing between the platform 104 and the flight vehicles 106. For example, most aircraft powered by combustion engines operate inside a national air space, which typically comprises altitudes below −18 kilometers (60,000 feet). Accordingly, in some embodiments the altitude A can be selected such that the laser beam 105 remains at an altitude entirely above 18 kilometers (60,000 feet) to avoid interfering with combustion aircraft. When the altitude A is ˜30 kilometers (60,000 feet), the FEL 110 can transmit the laser beam 105 ˜400 kilometers (248 miles) downrange without the laser beam 105 crossing below 18 kilometers (60,000 feet).

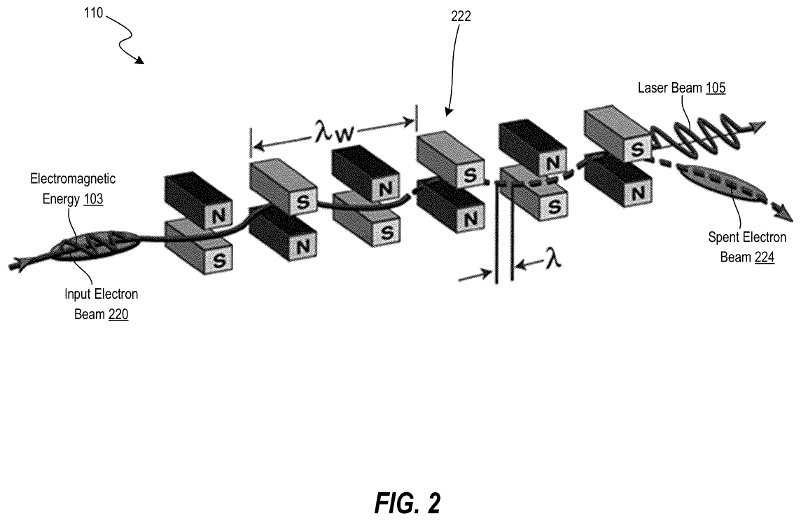

In some embodiments, the platform 104 comprises an aerostat. In some aspects of the present technology, aerostats support a wide RF receiver aperture, which can enhance the efficiency of collecting the electromagnetic radiation 103 transmitted from the transmitter 102. In some embodiments, the platform 104 comprises a winged vehicle loitering above the transmitter 102 above or below 18 kilometers (60,000 feet). In some embodiments, the platform 104 comprises a satellite orbiting Earth. In some embodiments, the platform 104 can be stationed near the edge of space (e.g., at and/or near the Kaman line) at the altitude A of ˜100 kilometers (328,000 feet). In such embodiments, the platform 104 can have a propulsion system for using the thin upper atmosphere as reaction mass for propulsion. Examples of such propulsion techniques are described in more detail in U.S. patent application Ser. No. 17/117,049, titled “PLASMA PROPULSION SYSTEMS AND ASSOCIATED SYSTEMS AND METHODS,” and filed Dec. 9, 2020, which is incorporated herein by reference in its entirety. The platform 104 can draw high power from the transmitted electromagnetic radiation 103 to use such propulsion technology to enable the platform 104 to “hover” at the altitude A close to 100 kilometers and/or to propel the platform 104 laterally at the altitude A. At the altitude A near 100 kilometers (328,084 feet), the FEL 110 can transmit the laser beam 105 ˜1,400 kilometers (870 miles) downrange without the laser beam 105 crossing below 18 kilometers (60,000 feet). In each of these embodiments, the FEL 110 can receive the electromagnetic radiation 103 (e.g., RF input) from the transmitter 102 and/or or another remote transmitter and utilize the electromagnetic radiation 103 both: (i) as a radiation (e.g., RF) input to the FEL 110 and (ii) to power an onboard electron beam generator to provide an electron beam input to the FEL 110—as described in greater detail below with reference to FIG. 2—to practically generate the laser beam 105 comprising strong kilowatt to megawatt level laser light for transmission from the platform 104 at high altitude.

The FEL 110 can combine the electromagnetic radiation 103 with an electron beam in a “wiggler” linear accelerator (linac) to generate the laser beam 105. In some embodiments, the electromagnetic radiation 103 can comprise RF waves. FIG. 2 is a schematic diagram of the FEL 110 in accordance with embodiments of the present technology. In the illustrated embodiment, input radiation in the form of the electromagnetic radiation 103 is paired with an input electron beam (e.g., an injected electron beam micropulse) and accelerated through a linear accelerator 222. The linear accelerator 222 can comprise a “wiggler” having alternating north-south polarity. The linear accelerator 222 has two outputs: (i) part of the electromagnetic radiation 103 emerges as output radiation in the form of the laser beam 105 and (ii) the rest forms a spent electron beam 224. In some embodiments, approximately 10% of the electromagnetic radiation 103 emerges from the linear accelerator 222 as the laser beam 105 with the rest as the spent electron beam 224. Referring to FIGS. 1 and 2, in some embodiments a first portion of the electromagnetic radiation 103 is fed directly into the FEL 110 and a second portion of the electromagnetic radiation 103 is received by a rectifying antenna (rectenna) carried by the platform 104 and converted into electricity. The electricity can be used to power an electron beam generator configured to generate the input electron beam 220 and/or other components of the platform 104. The input electron beam 220 can be generated by heat (thermionic emission), bombardment of charged atoms of particles (secondary electron emission), and/or strong electric fields (field emission). In some embodiments, the input electron beam 220 can be sourced from a sacrificial cathode.

In some embodiments, the output laser beam 105 has one or more tunable characteristics. For example, a wavelength λ of the laser beam 105 can be selected from the far infrared (IR) range, the near ultraviolet (UV) range, and/or X-ray range. In some embodiments, the wavelength λ of the laser beam 105 falls within the mid-infrared range (3-20 μm) or, more particularly, within the long-wave infrared (LWIR) range of between, for example, 8-14 μm (corresponding to a frequency from 37.4-21.4 THz). Accordingly, the output laser beam 105 can have a higher frequency (e.g., terahertz range) than the input electromagnetic radiation 103 (e.g., <300 gigahertz range). The FEL 110 is tunable to change the wavelength λ of the output laser 105. In contrast, gas and solid-state lasers generate light only at well-defined wavelengths.

In some aspects of the present technology, tuning the FEL 110 to output the laser beam 105 to have a relatively longer wavelength in the LWIR range can facilitate a smaller size and weight for the FEL 110, thereby reducing the power needed by the platform 104 to remain aloft at the altitude A. In additional aspects of the present technology, a LWIR laser output is advantageous because LWIR light propagates more freely in the upper atmosphere, allowing the laser beam 105 to reach the remote flight vehicles 106 downrange from the platform 104 with minimal energy loss. Additional details of FELs can be found in (i) “Lasers, Free-Electron,” by H. P. Freund & R. K. Parker, published 2001 in the third edition of the Encyclopedia of Physical Science and Technology, pgs. 397-398, and accessible at https://www.sciencedirect.com/science/article/abs/piiB0122274105003677; (ii) “Record high extraction efficiency of free electron laser oscillator,” by H. Zen et al., published Oct. 1, 2020 in Applied Physics Express 13 102007 on behalf of The Japan Society of Applied Physics by IOP Publishing Ltd., and accessible at https://iopscience.iop.org/article/10.35848/1882-0786/abb690; and/or (iii) “Airborne megawatt class free-electron laser for defense and security,” by R. Whitney et al., published Jun. 1, 2005 in Proceedings Volume 5792, Laser Source and System Technology for Defense and Security, and accessible at https://www.spi edi gitallib rary org/conference-proceeding s-of-spie/5792/0000/Airborne-megawatt-class-free-electron-laser-for-defense-and-security/10.1117/12.603906.short; each of which is incorporated by reference herein in its entirety.

In some embodiments, the FEL 110 can efficiently generate the output laser beam 105 having a high-power level suitable for powering the remote flight vehicles 106. For example, the resultant laser beam 105 generated by the FEL 110 can have a power level ranging from a couple kilowatts to one gigawatt or higher. The FEL 110 can operate at over 90% efficiency converting the incoming electromagnetic radiation 103 (e.g., RF power) into the laser beam 105 (e.g., laser light). More specifically, the FEL 110 can operate at relatively high efficiency compared to other laser methods. Gas and solid-state lasers generate light with energy-conversion efficiency of typically just a few percent. The FEL 110 can have far higher efficiency. For example, the FEL 110 can be coupled to an energy recovery linear accelerator (ERL) that diverts the spent electron beam 224 around and back into the linear accelerator 222 to form at least a portion of the input electron beam 220 to recover unused power.

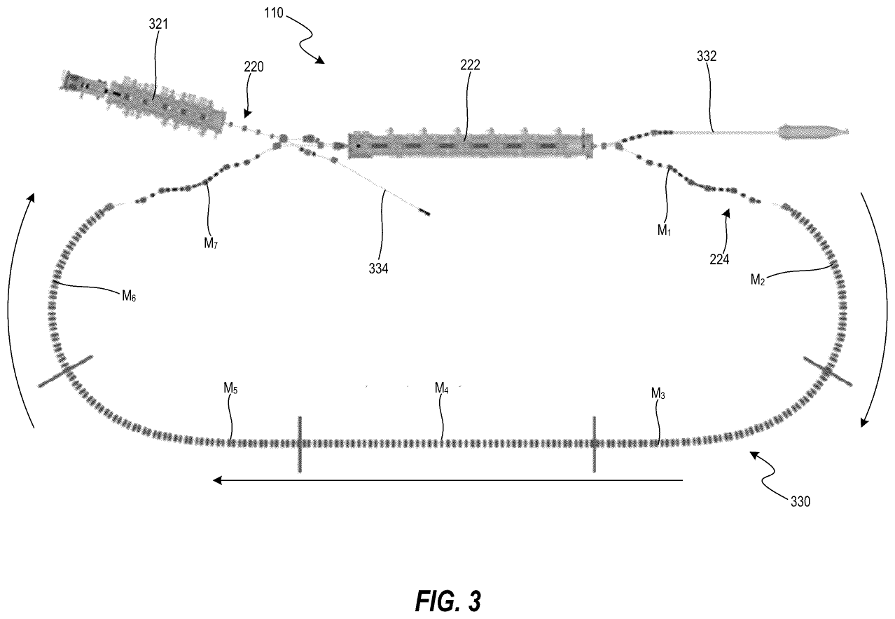

FIG. 3 is a schematic diagram of the FEL 110 of FIG. 2 coupled to an ERL 330 in accordance with embodiments of the present technology. In the illustrated embodiment, the FEL 110 includes an electron beam generator 321 (e.g., an injector) for injecting the input electron beam 220 into the linear accelerator 222 (e.g., a main linear accelerator). The ERL 330 comprises a loop of magnets M (including individually identified first through seventh magnets M₁-M₇, respectively) positioned to direct the spent electron beam 224 in a loop (e.g., in a clockwise direction indicated by arrows) for return to the linear accelerator 222 to recover unused power. The loop of magnets M can have a dimension on the order of tens of meters in length and/or width. The ERL 330 can further include a beam stop 332 and a diagnostic line 334. In some embodiments, the conversion efficiency from the RF input electromagnetic radiation 103 (FIGS. 1 and 2) to the output laser beam 105 (FIGS. 1 and 2) can be very high, achieving one-turn power balance ERL efficiency of 99.4%. The extraction efficiency of the output laser beam 105 relative to the power input into the system can also be high—for example 9.4% or greater. Accordingly, some aspects of the present technology enable RF conversion into FEL laser output at over 90% efficiency. This high efficiency reduces waste heat load, making it feasible to transfer power at multi-megawatt levels. Accordingly, referring to FIGS. 1-3, the FEL 110 and the ERL 330 can be used to wirelessly deliver megawatt (or greater) level power to the flight vehicles 106 positioned far downrange. Additional details of ERLs can be found in “Measurement of the per cavity energy recovery efficiency in the single turn Cornell-Brookhaven ERL Test Accelerator configuration,” by C. Gulliford et al, published Jan. 27, 2021 in Physical Review Accelerators and Beams 24, 010101, and accessible at https://journals.aps.org/prab/abstract/10.1103/PhysRevAccelBeams0.24.010101, which is incorporated herein by reference in its entirety. Alternatively, the spent electron beam 224 can be used as a power source (e.g., to generate electricity), and the generated power used to generate inputs to the FEL 110 (e.g., to generate the input electron beam 222 and the RF waves 103).

Referring to FIG. 1, the transmitter 102 is positioned to transmit the electromagnetic radiation 103 to the FEL 110 onboard the platform 104. In the illustrated embodiment, the transmitter 102 is positioned on the ground (e.g., at or adjacent to a surface of the Earth) remote from the platform 104. In other embodiments, the transmitter 102 can be positioned on the surface of the ocean, on a flight vehicle or other movable source, and/or at another position. For example, the transmitter 102 can be positioned on the platform 104 such that both the inputs for the FEL 110 (e.g., radio waves and electricity for generating the electron beam 220 (FIG. 2)) are generated onboard the platform 104. However, in some aspects of the present technology positioning the transmitter 102 remote from the platform 104, such as on the ground, can reduce the weight of the platform 104 carrying the FEL 110—thereby reducing the power required to maintain the platform 104 flying. Furthermore, positioning the transmitter 102 remote from the platform 104 can allow the transmitter 102 to be more robust, as it can freely switch between a wide variety of electrical sources such as the local electric-utility grid, a microgrid, solar arrays, windmills, diesel generators, and/or other electrical sources. Likewise, often electric power can be generated far less expensively on the ground compared to onboard a flight platform, particularly at high power levels in the range of hundreds of kilowatts to megawatts.

In some embodiments, the electromagnetic radiation 103 comprises radio frequency (RF) energy. RF energy is particularly suitable for transmission to the platform 104 when the platform is positioned above the troposphere, which typically extends from −8-14.5 kilometers (5-9 miles) above the Earth's surface, as RF energy easily transits from the ground through the troposphere. For example, 915 megahertz energy in the ultra-high frequency (UHF) band moves through tropospheric weather and water vapor. Accordingly, the electromagnetic radiation 103 can have a frequency that is passes relatively easily through the troposphere (e.g., between about 900 megahertz to 10 gigahertz). That is, the electromagnetic radiation 103 can have a frequency that is substantially transparent to the troposphere. “Substantially transparent” can mean that about 100%, about 90%, about 80%, about 70%, or about 60%, or between about 60%-100% of the electromagnetic radiation 103 passes entirely through the troposphere.

In some embodiments, the transmitter 102 is configured to transmit the electromagnetic radiation 103 to the FEL 110 as a Gaussian beam (e.g., waveform). A “Gaussian beam” refers generally to beams in which transverse magnetic and electric field amplitude profiles are given by the Gaussian function. For example, a Gaussian beam is a beam in which a peak electric field amplitude varies away from the center of the beam according to the function below, where x is radius, in the case of an axisymmetric beam, or can be x and y in the case of an elliptical Gaussian beam, where the constant in that case may be different in the x and y directions:

$${e}^{\frac{- {x}^{2}}{c o n s t a n t}}$$

In some instances, a Gaussian beam can also be truncated (i.e., cut off to zero amplitude for x>xₘₐₓ (again, where x may be radius or where it may be the x and y direction), without altering their essential character as a Gaussian beam. A Gaussian beam can also be slightly distorted, so long as it remains a smooth function, peaking in the center, without altering its essential character.

In some embodiments, the transmitter 102 is configured to transmit the electromagnetic radiation 103 to the FEL 110 as a non-Gaussian beam (e.g., waveform), such as a “Whisper Beam” transmission, as described in detail in U.S. Pat. No. 11,283,302, titled “NON-GAUSSIAN BEAMS FOR LONG-DISTANCE WIRELESS POWER TRANSMISSION,” and filed Dec. 11, 2019, which is incorporated herein by reference in its entirety. A “non-Gaussian beam” refers to a beam in which transverse magnetic and electric field amplitude profiles are not given by the Gaussian function. Additionally, or alternatively, a non-Gaussian beam can refer to any beam in which a peak electric field amplitude does not vary away from the center of the beam according to the function discussed above for Gaussian beams. A “Whisper Beam” transmission refers to a form of non-Gaussian beam. Whisper Beams form a diffuse core in which intensity at some point along a propagation axis between transmitter and the target focus region (such as, but not limited to, the midpoint between the transmitter and the focus area) is lower than intensity at some radius from that point. These beams sometimes mimic the quality of dispersing over a wide area and then recombining, analogous to a “whispering gallery.” A Whisper Beam can be formed by transmitting two or more coherent out-of-phase Gaussian beams along a propagation axis. The transmission of the two or more Gaussian beams can enable the generation of a diffuse-core beam that has an intensity along the propagation axis that is less than the highest intensity of the beam off the propagation axis.

In some aspects of the present technology, forming the electromagnetic radiation 103 as a non-Gaussian Whisper Beam transmission is particularly beneficial for transmitting the electromagnetic radiation 103 from the ground to the platform 104. First, such a transmission can have a higher power density than a Gaussian transmission. For example, natural diffraction dissipates standard gaussian transmissions as they propagate, spreading them out so that they may be weak by the time they reach the FEL 110 carried by the platform 104 at high altitude (e.g., stratospheric altitude). In contrast, non-Gaussian whisper beams can self-focus at high altitude (e.g., at the altitude A), and therefore can automatically funnel RF power into the FEL 110. Accordingly, for FELs operating over, for example, 18 kilometers (60,000 feet) altitude, Whisper Beam transmissions can substantially enhance and enable high power density output at the platform 104 for use in generating the laser beam 105 via the FEL 110. For example, the transmitter 102 can efficiently transmit the electromagnetic radiation 103 having a power level less than a kilowatt to over a gigawatt from the ground to the platform 104. Second, a non-Gaussian Whisper Beam transmission can reduce hazardous interference at altitudes below the platform 104 between the transmitter 102 and the platform 104. For example, conventional Gaussian transmissions tend to be strong along the transmission path (e.g., at low altitude between the transmitter 102 and the platform 104) and get weaker the farther they propagate (such as, e.g., at the FEL 110 carried by platform 104). In contrast, non-Gaussian Whisper Beams tend to be weak along the transmission path and become stronger at high altitude (e.g., at the FEL 110 carried by the platform 104). This characteristic can reduce or otherwise mitigate electromagnetic field levels experienced by any people, unintended aircraft, and/or wildlife who happen to wander into the path of the electromagnetic radiation 103 transmitted from the transmitter 102 to the FEL 110.

Referring again to FIG. 1, the FEL 110 transmits power to one or more of the flight vehicles 106 positioned downrange of the platform 104 (e.g., far downrange of the platform 104, such as up to 1400 kilometers or more depending on the altitude A of the platform 104). The flight vehicles 106 can comprise aircraft, aerostats, missiles, space launch vehicles, satellites, spacecraft, and/or the like. Accordingly, the flight vehicles 106 can be referred to as “downrange platforms” and/or the like and need not comprise a vehicle. In some embodiments, the flight vehicles 106 can comprise electric aircraft (eAircraft). Electric aircraft have many benefits including lower operating expenses and zero tailpipe chemical emissions. However, it has been historically difficult to supply high power (e.g., hundreds to thousands of kilowatts) to electric aircraft and other aircraft, such that conventional electric aircraft have limited range and carrying capacity due to the difficulty of storing electrical energy on board. Compared to fossil fuels used to store energy onboard a flight vehicle, batteries are relatively heavy and hydrogen for fuel cells is relatively bulky. As a result, using batteries or hydrogen for onboard energy storage can limit an electric vehicle's range and carrying capacity. In some aspects of the present technology, one or more of the flight vehicles 106 can comprise an electric aircraft that (i) receives power from the laser beam 105 generated by the FEL 110 carried by the flight platform 104 and (ii) converts the laser power to onboard electricity while the aircraft is in flight, extending its range and/or carrying capacity. Such an electric aircraft can use the received power for a variety of purposes, such as powering electric propulsion, onboard sensors (e.g., high-power radar), onboard computer equipment for data processing (e.g., “edge computing” equipment), and/or other power needs aboard the electric aircraft. Notably, the electric power need not include a battery, or may include a relatively smaller battery, as the power transmission from the FEL 110 can be continuous or frequent enough to reduce the power storage needs of the aircraft.

To convert the laser beam 105 into electric energy, the flight vehicles 106 can carry photovoltaic cells that receive all or a portion of the laser beam 105 and generate electricity through means commonly known by those skilled in the art. Other light to electrical conversion means can be used. For example, in other embodiments the flight vehicles 106 can carry a linear accelerator “wiggler” that uses the laser beam 105 as an input and forms electricity as an output (sometimes referred to as a “reverse FEL”). Such a reverse a reverse FEL can comprise an FEL operated in a reverse cycle from the FEL 110 described in detail above—i.e., absorbing laser energy and producing electrical power. Such a reverse FEL can have a very high conversion efficiency. In any case, the flight vehicles 106 could use the electricity generated from the received laser beam 105 to transfer power to the other flight vehicles 106.

The FEL 110 can target the laser beam 105 toward a select one of the flight vehicles 106 continuously or intermittently. Various methods commonly known to those skilled in the art can be used to enhance the targeting accuracy of the FEL 110. For example, a laser receiver on a targeted one of the downrange flight vehicles 106 can reflect a small fraction of the incoming laser beam 105 back to the FEL, modulating the reflected laser light. The transmitting FEL 110 can detect the modulated pattern in the reflected light, using it as confirmation that the laser beam 105 is accurately aimed at the intended receiver of the downrange flight vehicle 106.

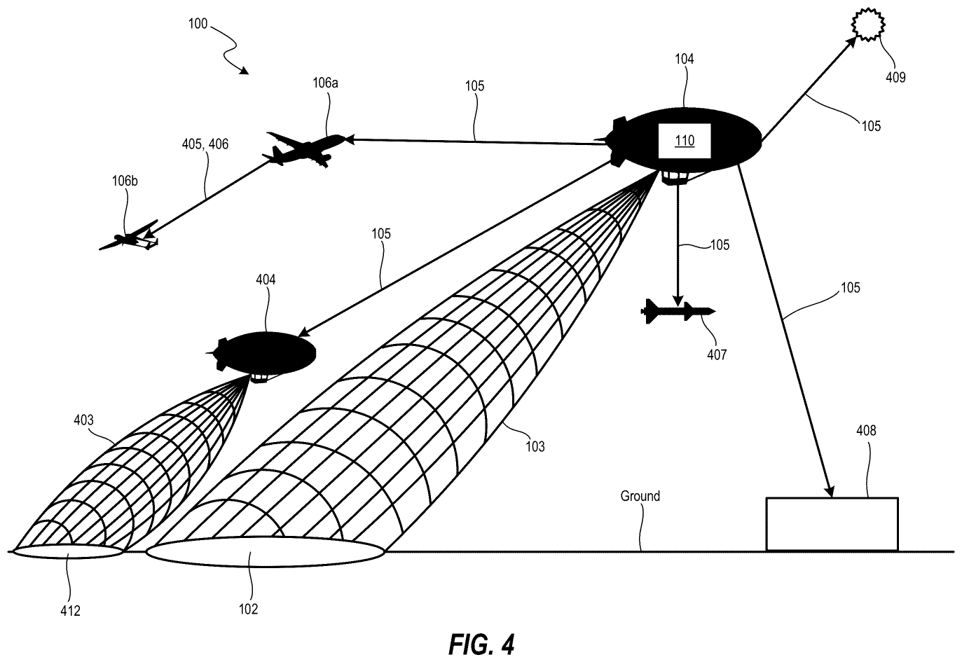

In additional embodiments, the FEL 110 can direct the laser beam 105 for purposes other than directly powering the downrange flight vehicles 106, such as for power relay between different ones of the flight vehicles 106, for point-to-point power relay to a ground target, for orbital debris removal, and/or as a directed energy weapon. FIG. 4, for example, is a schematic diagram of the power transmission system 100 in accordance with additional embodiments of the present technology. In the illustrated embodiment, the system 100 includes two of the flight vehicles 106 (including an individually identified first flight vehicle 106a and a second flight vehicle 106b). The FEL 110 can direct the laser beam 105 to the first flight vehicle 106a, and the first flight vehicle 106b can redirect the laser beam 105 as a redirected (e.g., reflected) laser beam 405 to the second flight vehicle 106b. The second flight vehicle 106b can be positioned farther (e.g., farther downrange) from the platform 104 than the first flight vehicle 106a. The second flight vehicle 106b can convert the redirected laser beam 405 to electricity for onboard use as described in detail above. The first flight vehicle 106a can redirect the laser beam 105 using one or more mirrors and/or other devices for redirecting or relaying laser power. In other embodiments, the first flight vehicle 106a can use the incoming laser beam 105 to generate electrical power, and use the electrical power to power an onboard laser to generate a new laser beam 406 to the second flight vehicle 106b. In this manner, laser energy (e.g., power) can be relayed long distances downrange of the transmitter 102, such as for powering an electric aircraft (e.g., the second flight vehicle 106a) in flight over an ocean. While two flight vehicles 106 are shown in FIG. 4, the system 100 can include more than two of the flight vehicles 106 that relay power therebetween (e.g., sequentially downrange). In other embodiments, the system 100 can include multiple ones of the platforms 104, each carrying a separate FEL 110. One flight FEL platform 104 can transfer power to a second flight FEL platform 104. This process can be repeated multiple times to successive flight FEL platforms. The final flight FEL platform in the relay chain can then relay power to a final consumer, such as, for example, an electric aircraft.

In some embodiments, the platform 104 (or multiple platforms 104 each carrying a FEL 110 and/or multiple flight vehicles 106 relaying laser power) can direct the laser beam 105 toward a receiver 408 positioned on the ground downrange of the transmitter 102. That is, the system 100 can relay power point-to-point from the ground transmitter 102 to the receiver 408. For example, the transmitter 102 can receive power from a renewable energy source and relay the power as the electromagnetic radiation 103 to the platform 104. The renewable energy source can be positioned near the transmitter 102 to limit energy loss therebetween. The receiver 408 can be a city downrange of the transmitter 102 and the renewable energy source. In some embodiments, the FEL 110 can be tuned as described in detail above such that the output laser beam 105 has a frequency that increases its ability to pass through the troposphere. In other embodiments, the flying platform 104 can be a first flying platform that relays power to a downrange second flying platform 404 (which can carry an FEL) using the laser beam 105. The downrange second flying platform 404 can relay that power down to a receiver 412 at surface (e.g., ground) level using an RF transmission 403 that easily passes through the troposphere, such as a non-Gaussian Whisper Beam transmission. The receiver 412 (or another component) can receive the RF transmission 403 and rectify it into electricity at the surface using rectification techniques readily known to those skilled in the art. Accordingly, the system 400 can include more than two flight platforms carrying FELs that relay power therebetween (e.g., sequentially downrange). In some such embodiments, the first flying platform 104 is a satellite and the second flying platform 404 is an aerostat. In some embodiments, transferring the RF transmission 403 over a short distance/altitude to the surface-based receiver 412 (e.g., from a flight platform at lower altitude than an orbiting satellite) can employ a surface-based receiver 412 of smaller aperture to collect comparable power from the RF transmission 403.

The renewable energy source can be a solar farm located in an area that receives sunlight after the sun has set near the city 408. For example, the solar farm can be located to the west of the city 408, such as a solar farm in Arizona feeding power to receivers in New York City. As another example, the solar farm can be located to the north or south of the city 408, supplying seasonal power. More specifically, in the Northern Hemisphere there are longer hours of daylight at far northern latitudes during late spring and early summer such that a solar farm located to the north of the city 408 (such as a solar farm in Alaska) can generate solar power after sunset and use the system 100 to relay that solar power to a southern city (such as Los Angeles). In this manner, cities can expand their use of renewable energy by continuing to draw power generated by solar arrays after sunset near the city 408.

In some embodiments, the platform 104 (or multiple platforms 104 each carrying a FEL 110 and/or multiple flight vehicles 106 relaying laser power) can direct the laser beam 105 toward orbital debris 409 to remove the orbital debris 409. For example, the laser beam 105 can heat the forward-facing surface of the orbital debris 409. The resulting outgassing from the forward-facing surface can generate a slight retro thrust, slowing the orbital debris 409, hastening its reentry and burn up in the atmosphere (a technique known to those skilled in the art and sometimes referred to as a “laser broom” for clearing orbital debris).

In yet additional embodiments, the platform 104 (or multiple platforms 104 each carrying a FEL 110 and/or multiple flight vehicles 106 relaying laser power) can direct the laser beam 105 toward a target 407 to destroy, damage, and/or disable the target 407. That is, the laser beam 105 can be used as a directed-energy weapon to destroy, damage, and/or disable the target 407, such as other flight vehicles, missiles, hypersonic vehicles, etc.

Referring to FIGS. 1-4, in some aspects of the present technology the FEL 110 can provide nearly continuous (e.g., unlimited) power flow for any of the various uses of the laser beam 105. Namely, the FEL 110 does not need to be supplied with gas and can be made available with any time structure for time periods from microseconds to hours. With RF power flowing continuously from the transmitter 102 via the electromagnetic radiation 103, there is a nearly unlimited power flow for the FEL 110 to generate the output laser beam 105.

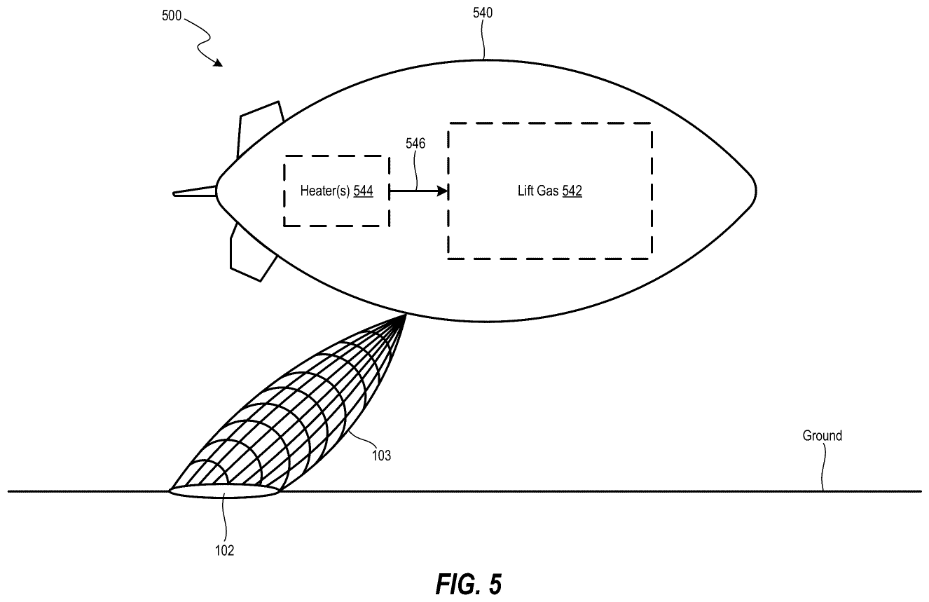

FIG. 5 is a schematic diagram of a system 500 for heating lift gas 542 within an aerostat 540 in accordance with embodiments of the present technology. The system 500 can include some features that are at least generally similar in structure and function, or identical in structure and function, to the corresponding features of the system 100 described in detail above with reference to FIGS. 1-4, and/or can operate in a generally similar or identical manner to the system 100. For example, in the illustrated embodiment the system 500 includes the ground-based power transmitter 102 positioned to transmit the electromagnetic radiation 103 (e.g., electromagnetic energy, RF waves) to the aerostat 540.

The lift gas 542 can comprise helium, hydrogen, air, and/or another buoyant gas, and the aerostat 540 can use the lift gas 542 to gain lift and remain aloft above the ground. In some embodiments, the aerostat 540 can operate at altitudes of 60,000 feet or higher and can comprise a high-altitude pseudo-satellite (HAPS). In the illustrated embodiment, the aerostat 540 includes one or more heaters 544 configured to receive the electromagnetic radiation 103 from the ground-based transmitter 102 and to convert the electromagnetic radiation 103 to heat 546 for heating the lift gas 542. The heater 544 can comprise a dedicated heater configured to generate the heat 546, or can comprise one or more electronic components dedicated to other functions of the aerostat 540 but that produce waste heat. For example, the heater 544 can comprise a rectifying antenna (rectenna) configured to receive the electromagnetic radiation 103 (e.g., radio waves) and convert the electromagnetic radiation 103 to electricity. Such a rectenna will generate some waste heat (e.g., the heat 546) while converting the electromagnetic radiation 104 to electricity that can be used for heating the lift gas 542. The electricity generated by the rectenna can be used for a variety of purposes, such as powering motors for positioning (e.g., station-keeping) the aerostat 540, powering sensors onboard the aerostat 540, powering an electron-beam generator for a FEL (e.g., the FEL 110 of FIGS. 1-4), etc.

In contrast, waste heat is typically a problem and/or complication on conventional flight (e.g., aerospace) vehicles that requires mitigation via cooling equipment. Accordingly, in some aspects of the present technology the aerostat 540 need not include any, or may include less, waste heat cooling equipment than conventional aerospace vehicles as the waste heat can be used productively as the heat 546 for heating the lift gas 542. Further, heating the lift gas 542 with the heat 546 can extend a duration that the aerostat 540 can remain aloft without requiring separate heating equipment. In some embodiments, the electromagnetic radiation 103 from the transmitter 102 can be supplied continuously or frequently enough that the heater 544 can produce a sufficient amount of the heat 546 to maintain the aerostat 540 aloft indefinitely, such as when the lift gas 542 is replaceable onboard the aerostat 540 (e.g., air).

The following examples are illustrative of several embodiments of the present technology:
1. A method of supplying electromagnetic radiation input to flight free electron laser (FEL), the method comprising:
supplying the electromagnetic radiation input to the flight FEL from a transmitter remote from the flight FEL.
2. The method of example 1 wherein the transmitter is positioned on the surface of the Earth.
3. The method of example 2 wherein supplying the electromagnetic radiation input includes transmitting the electromagnetic radiation at a radio frequency.
4. The method of any one of examples 1-3 wherein supplying the electromagnetic radiation input includes supplying the electromagnetic radiation input as a non-gaussian beam.
5. The method of any one of examples 1˜4 wherein supplying the electromagnetic radiation input includes supplying the electromagnetic radiation input as a Whisper Beam transmission.
6. The method of any one of examples 1-5 wherein supplying the electromagnetic radiation input includes supplying the electromagnetic radiation input at a radio frequency.
7. The method of any one of examples 1-6 wherein supplying the electromagnetic radiation input includes supplying the electromagnetic radiation input at a frequency that is substantially transparent to the troposphere.
8. The method of any one of examples 1-7 wherein supplying the electromagnetic radiation input to the flight FEL includes supplying the electromagnetic radiation input to the flight FEL while the flight FEL is positioned in or above the stratosphere.
9. The method of example 8 wherein the FEL is configured to (a) receive the electromagnetic radiation input and (b) generate a laser beam having a wavelength of between about 3-20 μm based at least partially on the electromagnetic radiation input.
10. A power transmission system, comprising:
a transmitter configured to transmit electromagnetic radiation;
a flight platform positioned remote from the transmitter; and
a free electron laser (FEL) carried by the flight platform, wherein the FEL is configured to (a) receive at least a portion of the electromagnetic radiation from the FEL and (b) generate a laser beam based at least in part on the received electromagnetic radiation.
11. The power transmission system of example 10 wherein the transmitter is positioned on the surface of the Earth, and wherein the flight platform is configured to fly at an altitude of 60,000 feet or more relative to the surface of the Earth.
12. The power transmission system of example 10 or example 11 wherein the laser beam has a wavelength of between about 3-20 μm.
13. The power transmission system of any one of examples 10-12, further comprising a downrange platform, wherein the FEL is configured to direct the laser beam toward the downrange platform.
14. The power transmission system of any one of examples 10-13 wherein the flight platform is an aerostat.
15. The power transmission system of any one of examples 10-14 wherein the FEL comprises (a) a main linear accelerator configured to generate the laser beam and (b) an energy recovery linear accelerator coupled to the main linear accelerator.
16. A method of transferring power, the method comprising:
transmitting electromagnetic radiation from a transmitter;
flying a flight platform at an altitude relative to the transmitter;
receiving, at a free electron laser (FEL) carried by the flight platform, at least a portion of the electromagnetic radiation; and
generating, via the FEL, a laser beam based at least in part on the electromagnetic radiation.
17. The method of example 16 wherein generating the laser beam comprises:
inputting a first portion of the electromagnetic radiation directly into the FEL while the flight platform is in flight at an altitude relative to the transmitter;
converting a second portion of the electromagnetic radiation to electricity onboard the flight platform;
using the electricity to generate an electron beam;
inputting the electron beam into the FEL; and
outputting the laser beam based on the first portion of the electromagnetic radiation and the electron beam.
18. The method of example 16 or example 17 wherein the method further comprises:
directing the laser beam away from the flight platform to a flight vehicle;
receiving the laser beam at the flight vehicle;
converting at least a portion of the laser beam to electricity; and
using the electricity in the flight vehicle.

19. The method of any one examples 16-18 wherein the method further comprises:
directing the laser beam away from the flight platform to a receiver on or adjacent to a surface of the Earth;
receiving the laser beam at the receiver; and converting at least a portion of the laser beam to electricity.
20. The method any one examples 16-19 wherein the method further comprises directing the laser beam to a target to at least partially destroy, damage, and/or disable the target.
21. A method of feeding power to a plasma propulsion system, the method comprising:
feeding power from an flight free electron laser (FEL) to the plasma propulsion system.
22. The method of example 21 wherein the plasma propulsion system is of the type described in U.S. patent application Ser. No. 17/117,049.
23. An aerostat, comprising:
a system for heating a lift gas, wherein the system is configured to receive wireless power to heat the lift gas.
24. The aerostat of example 23 wherein the system is configured to receive the wireless power from a ground transmitter to heat the lift gas.
25. A method for producing lift gas on an aerostat, the method comprising:
transmitting wireless power from a transmitter to the aerostat, wherein the aerostat includes one or more heaters, and wherein the transmitter is positioned at or adjacent to a surface of the Earth;
receiving the wireless power at the aerostat; and
using the wireless power to power the one or more heaters to produce heat for heating the lift gas.
26. The method of example 25 wherein the one or more heaters comprise an electronic component, and wherein the heat comprises waste heat from the electronic component.
27. The method of example 26 wherein the electronic component is a rectifying antenna configured to receive the wireless power and convert the wireless power to electricity.

All numeric values are herein assumed to be modified by the term about whether or not explicitly indicated. The term about, in the context of numeric values, generally refers to a range of numbers that one of skill in the art would consider equivalent to the recited value (e.g., having the same function and/or result). For example, the term about can refer to the stated value plus or minus ten percent. For example, the use of the term about 100 can refer to a range of from 90 to 110, inclusive. In instances in which the context requires otherwise and/or relative terminology is used in reference to something that does not include, or is not related to, a numerical value, the terms are given their ordinary meaning to one skilled in the art.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology, as those skilled in the relevant art will recognize. For example, although steps may be presented in a given order, in other embodiments, the steps may be performed in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase and/or as in A and/or B refers to A alone, B alone, and A and B. Additionally, the term comprising is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of supplying electromagnetic radiation input to flight free electron laser (FEL), the method comprising:
supplying the electromagnetic radiation input to the flight FEL from a transmitter remote from the flight FEL.

2. The method of claim 1 wherein the transmitter is positioned on the surface of the Earth.

3. The method of claim 2 wherein supplying the electromagnetic radiation input includes transmitting the electromagnetic radiation at a radio frequency.

4. The method of claim 1 wherein supplying the electromagnetic radiation input includes supplying the electromagnetic radiation input as a non-gaussian beam.

5. The method of claim 1 wherein supplying the electromagnetic radiation input includes supplying the electromagnetic radiation input as a Whisper Beam transmission.

6. The method of claim 1 wherein supplying the electromagnetic radiation input includes supplying the electromagnetic radiation input at a radio frequency.

7. The method of claim 1 wherein supplying the electromagnetic radiation input includes supplying the electromagnetic radiation input at a frequency that is substantially transparent to the troposphere.

8. The method of claim 1 wherein supplying the electromagnetic radiation input to the flight FEL includes supplying the electromagnetic radiation input to the flight FEL while the flight FEL is positioned in or above the stratosphere.

9. The method of claim 8 wherein the FEL is configured to (a) receive the electromagnetic radiation input and (b) generate a laser beam having a wavelength of between about 3-20 μm based at least partially on the electromagnetic radiation input.

10. A power transmission system, comprising:
a transmitter configured to transmit electromagnetic radiation;
a flight platform positioned remote from the transmitter; and
a free electron laser (FEL) carried by the flight platform, wherein the FEL is configured to (a) receive at least a portion of the electromagnetic radiation from the FEL and (b) generate a laser beam based at least in part on the received electromagnetic radiation.

11. The power transmission system of claim 10 wherein the transmitter is positioned on the surface of the Earth, and wherein the flight platform is configured to fly at an altitude of 60,000 feet or more relative to the surface of the Earth.

12. The power transmission system of claim 10 wherein the laser beam has a wavelength of between about 3-20 μm.

13. The power transmission system of claim 10, further comprising a downrange platform, wherein the FEL is configured to direct the laser beam toward the downrange platform.

14. The power transmission system of claim 10 wherein the flight platform is an aerostat.

15. The power transmission system of claim 10 wherein the FEL comprises (a) a main linear accelerator configured to generate the laser beam and (b) an energy recovery linear accelerator coupled to the main linear accelerator.

16. A method of transferring power, the method comprising:
transmitting electromagnetic radiation from a transmitter;
flying a flight platform at an altitude relative to the transmitter;
receiving, at a free electron laser (FEL) carried by the flight platform, at least a portion of the electromagnetic radiation; and
generating, via the FEL, a laser beam based at least in part on the electromagnetic radiation.

17. The method of claim 16 wherein generating the laser beam comprises:
inputting a first portion of the electromagnetic radiation directly into the FEL while the flight platform is in flight at an altitude relative to the transmitter;
converting a second portion of the electromagnetic radiation to electricity onboard the flight platform;
using the electricity to generate an electron beam;
inputting the electron beam into the FEL; and
outputting the laser beam based on the first portion of the electromagnetic radiation and the electron beam.

18. The method of claim 16 wherein the method further comprises:
directing the laser beam away from the flight platform to a flight vehicle;
receiving the laser beam at the flight vehicle;
converting at least a portion of the laser beam to electricity; and
using the electricity in the flight vehicle.

19. The method of claim 16 wherein the method further comprises:
directing the laser beam away from the flight platform to a receiver on or adjacent to a surface of the Earth;
receiving the laser beam at the receiver; and
converting at least a portion of the laser beam to electricity.

20. The method of claim 16 wherein the method further comprises directing the laser beam to a target to at least partially destroy, damage, and/or disable the target.
